(19) United States
(12) Patent Application Publication
(10) Pub. No.: US 2008/0282115 A1
(43) Pub. Date: Nov. 13, 2008

(54) CLIENT-SERVER TEXT MESSAGING MONITORING FOR REMOTE COMPUTER MANAGEMENT

(76) Inventors: Ronald M. Buswell, Colchester, VT (US); Eric J. Morin, Milton, VT (US)

Correspondence Address: HOFFMAN WARNICK LLC, 75 STATE STREET, 14TH FLOOR, ALBANY, NY, 12207, US

(21) Appl. No.: 12/176,822

(22) Filed: Jul. 21, 2008

Related U.S. Application Data
(63) Continuation of application No. 10/065,729, filed on Nov. 13, 2002, now abandoned.

(51) Int. Cl. G06F 11/30

(52) U.S. Cl. 714/47; 714/E11.179

(57) ABSTRACT

Implementation of a client-server text messaging (CSTM) monitor installed on a computer system that is configured to monitor a client-server text messaging (CSTM) server for commands posted thereto, and a management program installed on the computer system which is responsive to the commands. The CSTM monitor is lightweight and allows multiple computer systems to monitor a CSTM server and execute posted commands. Managed computer systems are more efficient because the management program does not run continuously. The commands are text-based and, therefore, require very little network bandwidth between a management system and the managed computer system. The invention allows a centralized computer management system to monitor managed computer systems and implement corrective measures without overburdening the systems or network bandwidth.

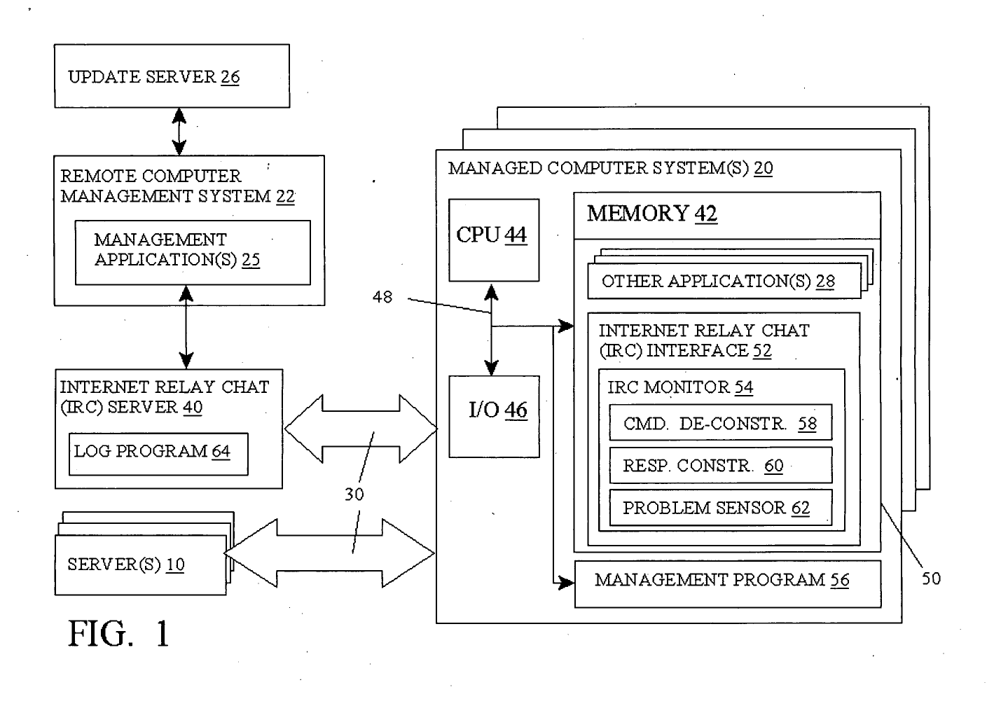

### CROSS REFERENCE TO RELATED APPLICATIONS

This application is a continuation application of pending U.S. patent application Ser. No. 10/065,729, filed on Nov. 13, 2002.

### BACKGROUND OF THE INVENTION

1. Technical Field

The present invention relates generally to remote computer management, and more particularly to a client-server text messaging monitor for implementing remote computer management.

2. Related Art

Computer networks include a number of dispersed computer systems. In order for network administrators to determine what activities or problems are occurring on the dispersed computer systems, a centralized management system is oftentimes implemented. The centralized management system includes a variety of applications to monitor, evaluate and correct performance problems of the dispersed, managed computer systems. In order for the management system to collect data about the dispersed managed computer systems, each managed computer system typically requires some sort of computer management program to be continuously running thereon. These management programs are large and robust applications that affect managed computer system performance. For example, since these management programs run continuously in the background, they tend to overload system memory (RAM). Accordingly, the management program may generate some of the problems it is provided to remedy.

Another problem with a centralized management system is that corrective measures must be implemented one managed computer system at a time, which is labor intensive and time consuming. As a result, some remedial steps are overlooked or not implemented when required.

Another problem with a centralized management system is that they require large amounts of network bandwidth. This is especially the case with low latency where network administrator's mouse/keyboard inputs are transmitted to the managed computer or the managed computer's monitor images are sent to the network administrator. One example of where this problem also arises is implementing an update to a large number of managed computer systems. This problem is magnified where users are in a widely distributed, low bandwidth or high latency network.

In view of the foregoing, there is a need in the art for an improved way to manage computer systems and implement corrective measures without overburdening the managed systems or network bandwidth.

### SUMMARY OF THE INVENTION

The invention includes implementation of a client-server text messaging (CSTM) monitor installed on a computer system that is configured to monitor a CSTM server for commands posted thereto, and a management program installed on the computer system which is responsive to the commands. The CSTM monitor is lightweight and allows multiple computer systems to monitor a CSTM server, and execute commands posted thereon. Managed computer systems are more efficient because the management program does not run continuously. The commands are text-based and, therefore, require very little network bandwidth between network administrator and managed computer system. The invention allows a centralized computer management system to monitor managed computer systems and implement corrective measures without overburdening the systems or network bandwidth.

A first aspect of the invention is directed to a system for performing remote computer system management, the system comprising: a client-server text messaging (CSTM) monitor installed on a computer system, the monitor configured to monitor a CSTM server for commands posted thereto; and a management program installed on the computer system which is responsive to the commands.

A second aspect of the invention is directed to a method of managing a managed computer system, the method comprising the steps of: monitoring a client-server text messaging (CSTM) server for a command posted thereto, each command including a computer system identifier for the command and an instruction; and receiving the command at the managed computer system and executing the instruction with a management program.

A third aspect of the invention is directed to a computer program product comprising a computer useable medium having computer readable program code embodied therein for implementing remote computer management of a computer system, the program product comprising: program code configured to monitor a client-server text messaging (CSTM) server for a command, each command including a computer system identifier for the command and an instruction; and program code configured to manage the computer system responsive to the instruction.

The foregoing and other features of the invention will be apparent from the following more particular description of embodiments of the invention.

### BRIEF DESCRIPTION OF THE DRAWINGS

The embodiments of this invention will be described in detail, with reference to the following FIGURE, wherein like designations denote like elements, and wherein:

The FIGURE shows a block diagram of a network including a remote computer management system and managed computer system(s) implementing a client-server text messaging monitor according to the invention.

### DETAILED DESCRIPTION OF THE INVENTION

Referring now to the FIGURE, an architecture of systems, methods and computer program products for performing remote computer management according to the invention will now be described. It will be understood that systems, methods and computer program products according to the invention are preferably implemented as a stored program that executes on a data processing system. A legacy data processing system, such as an IBM Model S/390 may be used. Alternatively, however, midrange or personal system and a network of legacy, midrange and personal systems may be used.

As shown in the FIGURE, a computer network system 8 may include one or more server(s) 10 coupled to one or more remote computer system(s) 20 by a network 30. Computer system(s) 20 access server(s) 10, which provide practically any functionality required by the organization using network system 8. For instance, server(s) 10 may provide file storage, applications, user authentication, electronic mail, etc. Network 30 may be of any form now known or later developed for electronic communication between computer systems. For example, network 30 may be: the Internet, an intranet, a local area network, a wide area network, an interactive television network, a telephone network, a wireless data transmission system, a two-way cable system, a customized computer network, etc.

In order to manage remote computer system(s) 20 and server(s) 10, a remote computer management system 22 is provided. Management system 22 may include an administrator and/or any of a variety of management application(s) 24 such as those provided by Tivoli® that function to evaluate, monitor and correct problems on managed computer systems 20. As recognized by those skilled in the art, management system 22 may be provided as part of one of server(s) 10 or as an entirely separate system. An update server 26 may also be provided as part of or as a separate unit for use with management system 22. Update server 26 functions to provide updates to server(s) 10 and/or application(s) 28 that are resident on each managed computer system 20, as will be described in more detail below.

A client-server text messaging (CSTM) server 40 is also provided. CSTM server 40 may be any now known or later developed system for communication of text messages between clients (e.g., managed computers system(s) 20), servers (e.g., server(s) 10, CSTM server 40, etc.) or a combination thereof. “Text messaging” is sometimes referred to as “chat.” In one embodiment, CSTM server 40 may be configured to operate according to Internet relay chat (hereinafter “IRC”) protocol. IRC protocol is a set of rules for posting and viewing messages in a channel, maintaining the channel, authenticating users and server/network architecture. IRC protocol is promulgated by the Internet Engineering Task Force (IETC) according to Request for Comments (RFC) 1459, 2810, 2811-2813. It should be recognized that such protocols are subject to periodic change and that revisions thereto are considered within the scope of the invention. IRC allows for hidden or non-published channels to be created allowing for security. IRC also allows for locked channels that require user authentication to join the channel. It should be recognized by one with skill in the art, however, that CSTM server 40 may be configured to operate based on other more general protocols/rules and not depart from the scope of this invention. It should further be recognized that while CSTM server 40 is shown as a separate unit, it can be provided as part of other servers or systems.

Each managed computer system 20 may include a memory 42, a central processing unit (CPU) 44, input/output device(s) (I/O) 46 and a bus 48. Memory 42 includes a program product 50 that, when executed by CPU 44, provides various functional capabilities described in further detail below. Memory 42 may comprise any known type of data storage system and/or transmission media, including magnetic media, optical media, random access memory (RAM), read only memory (ROM), a data object, etc. Moreover, memory 42 may reside at a single physical location comprising one or more types of data storage, or be distributed across a plurality of physical systems. CPU 44 may likewise comprise a single processing unit, or a plurality of processing units distributed across one or more locations, which utilize standard operating system software designed to drive the operation of the particular hardware and which is compatible with other system components and I/O controllers. I/O 46 may comprise any known type of input/output device including a network system, modem, keyboard, mouse, scanner, voice recognition system, CRT, printer, disc drives, etc. Additional components, such as cache memory, communication systems, system software, etc., may also be incorporated into each managed computer system 20.

As shown in the FIGURE, program product 50 may include, inter alia, other application(s) 28 and a client-server text messaging (CSTM) interface 52. Applications 28 can provide any general type of functionality required by computer system 20 users. CSTM interface 52 includes a client-server text messaging (CSTM) monitor 54 that may include a command de-constructor 58, a response constructor 60 and a problem sensor 62, all of which will be described in more detail below. A non-memory (RAM) resident management program 56 is also included. Management program 56 may include any now known or later developed computer management utility that is responsive to commands issued by management system 22. Functionally, management program 56 may include, for example, antivirus software, disk defragmenters, disk cleaners, crash-prevention and reporting software, security utilities, account management software, etc.

CSTM interface 52 can be any well known memory resident program that allows normal chat activity to occur. That is, communication of text-based information between various computer systems. CSTM monitor 54, however, is configured to monitor a specific CSTM server 40 for commands for management program 56 posted periodically. CSTM monitor 54 monitors posts to the server, and command de-constructor 58 thereof filters out commands addressed to the corresponding managed computer system 20. When a command is received, it is passed to larger, more robust management program 56. Since management program 56 is non-memory resident, it can be idle until it receives a command to run, which reduces the burden on computer system resources. In addition, as will be described below, CSTM monitor 54 is configured to receive data from management program 56 and construct a response using response constructor 60. Each response is posted to CSTM server 40 and addressed to management system 22.

In one embodiment, a command may be a simple text string. For example, a command may be in the general form: “˜cmd, identifier, instruction.” In order for command de-constructor 60 to filter commands directed to CSTM monitor 54, commands may be prefaced by special characters, e.g., “˜cmd,” to signal CSTM monitor 54 that a command follows. Use of a preface allows normal chat operation in the channel between managed computer(s) 20 and others to continue. The next portion of the command, i.e., the “identifier,” is a CSTM monitor identifier which is unique to each CSTM monitor 54 and, accordingly, is unique to each computer system 20. An identifier may include, for example, the Internet protocol (IP) address, host name, security ID, etc., for a particular managed computer 20. For example: “˜cmd 192.168.1.1, run” may indicate that the managed computer system 20 with the CSTM monitor 54 with identifier 192.168.1.1 is the intended recipient. Similarly, managed computer systems 20 can be addressed in groups. For example, a special identifier, e.g., “all,” may identify commands to be carried out by all managed computer systems' management programs. Other exemplary group structure may include: IP address range, host names, workgroup association, business area, etc. The final part of the command is the “instruction,” which directs management program 56 how, or what, to execute. The instruction could be anything that the non-memory resident management program 56 would accept. Examples include administrative tasks, software updates, virus protection, etc. for computer system 20.

In addition to receiving instructions, management program 56 is configured to pass success/failure and/or detailed information back to CSTM monitor 54 in the form of the above-mentioned response. A response is generated by response constructor 60 when data is passed to it from management program 56. Each response is posted by CSTM interface 52 to CSTM server 40 and addressed to management system 22. A response may take a similar form as a command. For example, a response may be text-based and in the form of “˜resp, identifier, response.” In this case, the preface “˜resp” indicates to CSTM server 40 that the post is a response, “identifier” identifies management system 22 as the addressee, and “response” is the actual response, e.g., success, failure or more detailed information. In this way, network administrators are able to view success/failure information and detailed information about any problem encountered while attempting to execute a command.

The above-described system, method and program product reduce the amount of computer system 20 resources used by a management program 56 since it is not continuously running. In addition, since the commands can be text-based, they require very little network 30 bandwidth between management system 22 and managed computer system 20. Accordingly, the invention allows a centralized computer management system 22 to monitor managed computer system(s) 20 and implement corrective measures without overburdening the system(s) 20 or network 30 bandwidth. The system, method and program product also allow mass management through the use of CSTM commands targeted at all managed computer systems 20. Using group management can reduce time and overhead required to, for example, implement updates to large numbers of managed computer systems 20. In this scenario, information required to identify updates and connect to an update server(s) 26 would be posted by CSTM server 40 using the command language, received by CSTM monitor 54 and passed to management program 56 for execution.

CSTM monitor 54 may also be configured to sense or identify problems on managed computer system 20 as they occur or even before they occur using a problem sensor 62. This functionality may be provided by having problem sensor 62 receive error messages that are normally detected or tracked by other components, e.g., the operation system's system log, hard drive system monitors, etc. CSTM monitor 54 would then send this information to CSTM server 40 for management system 22 analysis, i.e., post the information in the form of a response. Management system 22 would then post an appropriate command to CSTM server 40 to be picked up by the corresponding CSTM monitor 54 and executed by management program 56 to correct the problem. Analysis by management system 22 could be automated to work from a knowledge base that monitors CSTM server 40 for problem posts by managed computer system(s) 20 and then post a command to fix the problem. For purposes of trend analysis, a log program 64 can be provided with CSTM server 40 to implement logging of CSTM server activity, i.e., logging posted commands and received responses.

In the previous discussion, it will be understood that each element of the illustration, and combinations of elements in the illustration, can be implemented by general and/or special purpose hardware-based systems that perform the specified functions or steps, or by combinations of general and/or special purpose hardware and computer instructions. These program instructions may be provided to a processor to produce a machine, such that the instructions that execute on the processor create means for implementing the functions specified in the illustration. The computer program instructions may be executed by a processor to cause a series of operational steps to be performed by the processor to produce a computer implemented process such that the instructions which execute on the processor provide steps for implementing the functions specified in the illustrations. Accordingly, the FIGURE supports combinations of means for performing the specified functions, combinations of steps for performing the specified functions and program instruction means for performing the specified functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

What is claimed is:

1. A system for performing remote computer system management, the system comprising:
a client-server text messaging (CSTM) monitor installed on a computer system, the monitor configured to monitor a CSTM server for a command from a management system posted thereto, the management system functioning to correct a problem on the computer system; and
a management program installed on the computer system which is responsive to the command from the management system.

2. The system of claim 1, wherein the CSTM monitor and server are configured to function according to Internet relay chat protocol.

3. The system of claim 1, wherein the command is in the form of a text string.

4. The system of claim 1, wherein the command includes a preface, an identifier and an instruction for the management program.

5. The system of claim 1, wherein the CSTM monitor is also configured to post a response from the management program to the CSTM server.

6. The system of claim 1, wherein the CSTM server includes a log program configured to record CSTM server activities.

7. The system of claim 1, wherein the CSTM server is configured to receive commands from an update server.

8. The system of claim 1, wherein the CSTM monitor is also configured to sense a problem in the computer system.

9. The system of claim 1, wherein the management program is idle until it receives a command.

10. A method of managing a managed computer system, the method comprising the steps of:
monitoring a client-server text messaging (CSTM) server for a command from a management system posted thereto, the management system functioning to correct a problem on the computer system and each command including a computer system identifier for the command and an instruction; and
receiving the command at the managed computer system and executing the instruction with a management program.

11. The method of claim 10, wherein the command is in the form of a text string.

12. The method of claim 10, wherein the CSTM server is configured to function according to Internet relay chat protocol.

13. The method of claim 10, further comprising the step of sensing a problem in the computer system and posting a response to the CSTM server and channel regarding the problem.

14. A computer program product comprising a computer useable medium having computer readable program code embodied therein for implementing remote computer management of a computer system, the program product comprising:
program code configured to monitor a client-server text messaging (CSTM) server for a command from a management system posted thereto, the management system functioning to correct a problem on the computer system and each command including a computer system identifier for the command and an instruction; and
program code configured to manage the computer system responsive to the instruction.

15. The program product of claim 14, wherein the program code is configured to monitor functions according to Internet relay chat protocol.

16. The program product of claim 14, wherein the command is in the form of a text string.

17. The program product of claim 14, wherein the command includes a preface, an identifier and an instruction for the management program code.

18. The program product of claim 14, further comprising program code configured to record posted commands at the CSTM server.

19. The program product of claim 14, further comprising program code configured to sense a problem in the computer system and post a response to the CSTM server regarding the problem.

20. The program product of claim 14, further comprising program code configured to post a response from the management program to the CSTM server.
